(19) United States
(12) Patent Application Publication
(10) Pub. No.: US 2026/0089622 A1
(43) Pub. Date: Mar. 26, 2026

(54) TECHNOLOGIES FOR CELL SELECTION AND RESELECTION IN NETWORK ENERGY SAVING NETWORKS

(71) Applicant: Apple Inc., Cupertino, CA (US)

(72) Inventors: Peng Cheng, Beijing (CN); Fangli Xu, Beijing (CN); Yuqin Chen; Haijing Hu, Los Gatos, CA (US)

(73) Assignee: Apple Inc., Cupertino, CA (US)

(21) Appl. No.: 19/111,307

(22) PCT Filed: Sep. 16, 2022
(86) PCT No.: PCT/CN2022/119374

§ 371 Date: Mar. 12, 2025

(51) Int. Cl. H04W 52/02; H04W 48/20

(52) U.S. Cl. CPC H04W 52/0206; H04W 48/20

(57) ABSTRACT

The present application relates to devices and components including apparatus, systems, and methods for cell selection and reselection in network energy saving networks.

### TECHNICAL FIELD

This application relates generally to wireless communication, and in particular relates to technologies for cell selection and reselection in network energy saving networks.

### BACKGROUND

Currently, Third Generation Partnership Project (3GPP) efforts are being made with respect to network energy savings. These include efforts to study and identify techniques on the network side and the user equipment (UE) side to improve network energy savings in terms of both base station transmission and reception. Consideration is given on how to achieve more efficient operation dynamically or semi-statically and enable finer granularity adaptation of transmissions or receptions in network energy saving techniques in time, frequency, spatial, and power domains.

### BRIEF DESCRIPTION OF THE DRAWINGS

FIG. 1 illustrates a network environment, in accordance with some embodiments.

FIG. 2 illustrates an operational flow/algorithmic structure in accordance with some embodiments.

FIG. 3 illustrates another operational flow/algorithmic structure in accordance with some embodiments.

FIG. 4 illustrates another operational flow/algorithmic structure, in accordance with some embodiments.

FIG. 5 illustrates another operational flow/algorithmic structure, in accordance with some embodiments.

FIG. 6 illustrates an user equipment in accordance with some embodiments.

FIG. 7 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components of devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

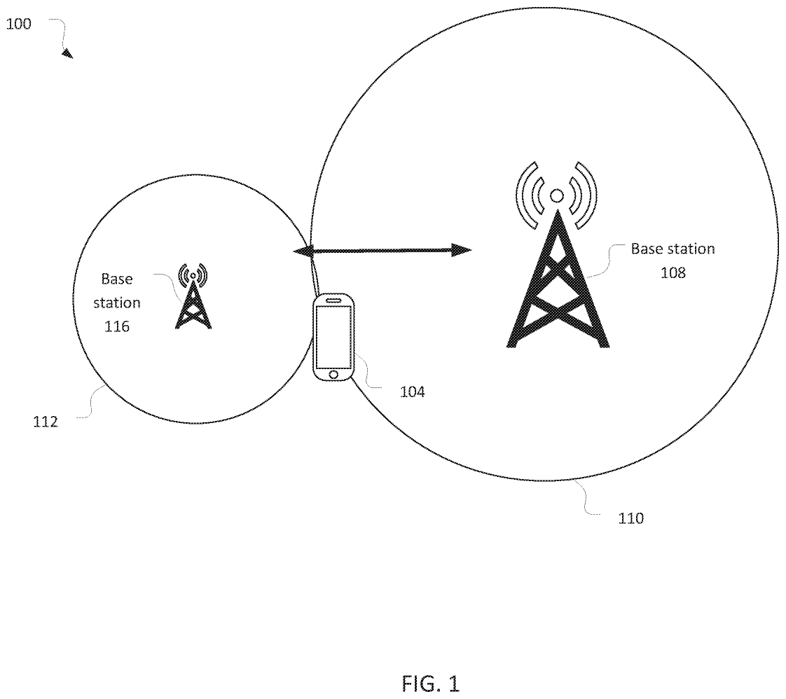

FIG. 1 illustrates a network environment 100 in accordance with some embodiments. The network environment 100 may include a UE 104 and a base station 108. The base station 108 may provide a serving cell (SC) 110 through which the UE 104 may communicate with the base station 108. In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define Fifth Generation (5G) NR or later system standards.

The network environment 100 may further include one or more neighbor base stations that provide non-serving cells. For example, the network environment 100 may include base station 116 that provides non-serving cell (NSC) 112. The base station 116 may use the same radio access technology as the base station 108 or a different radio access technology.

The UE 104 may perform various cell measurements as part of an initial cell selection procedure or a cell reselection procedure. In general, the cell selection procedure may be performed when the UE 104 is not currently associated with a serving cell, while the cell reselection procedure may be performed when the UE 104 is camped on a serving cell. For example, if the UE 104 is camped on the serving cell 110 in a radio resource control (RRC) idle or inactive state, it may measure the NSC 112 as a candidate for cell reselection. For reselection, the UE 104 may compare neighbor-cell measurements against a cell selection receive-level threshold (Srxlev) or a cell selection quality-level threshold (Squal). These comparisons may be based on parameters provided by the serving cell or by a target neighbor cell.

One or more of the base stations of the network environment 100 may be configured to provide network energy-saving (NES) cells. An NES cell may be configured to provide one or more of the following NES techniques.

In a first NES technique, an NES cell may reduce synchronization signal block (SSB) or system information block 1 (SIB1) transmissions to save power. For example, an NES-enabled base station may be allowed to use an SSB with a relatively longer periodicity, and may not even send a SIB1, or may send the SIB1 on demand.

In a second NES technique, the NES cell may perform cell discontinuous reception (DRX) or discontinuous transmission (DTX) in which the base station enters a sleep mode/state during a DRX/DTX off duration. During the sleep mode/state, the base station may not transmit or receive some signals or channels.

In a third NES technique, the NES cell may perform a dynamic cell on/off. This dynamic on/off may be a fast transition using, for example, layer 1 (L1) or layer 2 (L2) signaling.

In a fourth NES technique, the NES cell may rely on an uplink wake-up signal (WUS). The uplink WUS may be an L1 signal from a UE to notify the base station to wake up from a sleep mode/state.

While these NES techniques may work to save energy at the network level, they may also increase latency experienced by the UE for initial access. For example, when the SSB periodicity is large or not present or when cell DRX is running, a UE may experience a significant increase in initial access latency. This may be especially true for legacy UEs that may assume a default SSB periodicity of 20 ms. These NES techniques may also decrease a UE's radio resource management (RRM) performance and impact quality of service (QoS) performance, especially for legacy UEs that do not have tools to enhance performance. Therefore, it may be beneficial for an NES-capable UE to camp on an NES cell much as possible, while the legacy UEs should avoid camping on these cells. For the purposes of the present description, the UE 104 may be considered an NES-capable UE.

Embodiments of the present disclosure describe how an NES-capable UE, such as UE 104, may prioritize cells for camping during cell selection or reselection and how legacy UEs are to avoid camping on NES cells.

In an initial cell selection, a UE may obtain desired information in real-time from serving or non-serving cells. In some instances, a UE may be able to leverage previously stored cell information for the initial cell selection. In the legacy cell-selection procedure, a UE will determine a cell on which to camp only based on radio conditions. Priorities between different frequencies or radio access technologies may not be used. At each frequency, the UE may only search for the strongest cell, except for operation with shared spectrum channel access with the UE may search for the next strongest cell. Once a suitable cell is found, it may be selected for camping.

With respect to initial accesses, it may be desirable for an NES-capable UE to camp on a non-NES cell as much as possible. This may avoid the scenario in which the strongest cell in one frequency is in an NES cell and the UE has to wait a long time for its SSB to complete an initial access. If NES-capable UEs utilize non-NES cells for initial access, it may be possible to reduce or eliminate impact on an access latency key performance indicator (KPI).

In order to allow an NES-capable UE the option of selecting a non-NES cell for initial access, some embodiments provide that NES-capable UEs are allowed to search for the top N strongest cell(s) during an initial cell selection. The value N may be an integer greater than one, which may be broadcast in a SIB, predefined by a 3GPP Technical Specification (TS), or preconfigured as part of the UE's subscription.

The UE 104 may be configured with RRM requirements that are to be used in evaluating a cell for purposes of initial cell selection or cell reselection. The RRM requirements may provide an indication of which cells or resources are to be measured, the type of measurements to be performed, the number or frequency of the measurements that are to be performed to support RRM operations, etc. In general, the RRM requirements may be similar to those described in 3GPP TS 38.133 v17.6.0 (2022-06). The UE 104 may be configured with two sets of RRM requirements. A first set may be referred to as unrelaxed RRM requirements, which may be configured for general use. A second set may be referred to as relaxed RRM requirements, which may be configured for use in certain scenarios such as when the UE is in a low-mobility state or is not located at a cell-edge. In some embodiments, the UE 104 may utilize the unrelaxed RRM requirements when performing measurements on non-NES cells and may utilize the relaxed RRM requirements when performing measurements on NES cells. Thus, for the initial cell selection, the UE 104 may use the unrelaxed RRM requirements as it may be targeting a non-NES cell.

To enable differentiated treatment of NES cells and non-NES cells, the UE 104 may need to reliably determine whether a candidate cell is an NES cell or a non-NES cell for purposes of initial cell selection or cell reselection. In some embodiments, the UE 104 may identify whether a particular candidate cell is an NES cell or a non-NES cell based on one or more of the following options.

In a first option, the base station may set an explicit bit in a broadcast message that indicates whether its cell is an NES cell. For example, a base station may transmit a SIB message with a bit of an NES cell indication field set to indicate whether its cell is an NES cell. In some embodiments, the base station may set the bit to ‘1’ to indicate its cell is an NES cell and may set the bit to ‘0’ to indicate its cell is a non-NES cell.

In a second option, the UE 104 may determine whether a candidate cell is an NES cell based on a periodicity of an SSB of the cell. For example, the UE 104 may detect an SSB to determine its periodicity. If the periodicity is greater than a predetermined threshold, the UE 104 may determine the cell is an NES cell.

In a third option, the UE 104 may determine whether a candidate cell is an NES cell based on whether an SSB is present. For example, the UE 104 may decode a SIB1 to obtain one or more parameters that indicate whether an SSB is transmitted by the cell. If the SSB is not transmitted by the cell, the UE 104 may determine the cell is an NES cell.

In a fourth option, the UE 104 may determine whether a candidate cell is an NES cell based on whether a SIB1 is broadcast. For example, the UE 104 may determine whether the SIB1 is broadcast by the cell by attempting to find/decode the SIB1. If the SIB1 is not broadcast by the cell, the UE 104 may determine the cell is an NES cell.

In a fifth option, the UE 104 may determine whether a candidate cell is an NES cell based on whether cell DRX/DTX is configured. The cell DRX/DTX configuration may be provided in a SIB transmission of the cell. If cell DRX/DTX is configured, the UE 104 may determine the cell is an NES cell.

In a sixth option, the UE 104 may determine whether a candidate cell is an NES cell based on whether an uplink WUS is configured. The uplink WUS configuration of a cell may be provided by a SIB transmitted by the cell. If the uplink WUS configuration is present in the SIB, the UE 104 may determine the cell is an NES cell.

In a seventh option, the UE 104 may determine whether a candidate cell is an NES cell based on whether a discovery reference signal (RS) is detected. A discovery RS may be configured to enable a fast cell switch. If the discovery RS is detected, the UE 104 may determine the cell is an NES cell.

In an eighth option, the UE 104 may determine whether a candidate cell is an NES cell based on a periodicity associated with an SSB measurement timing configuration (SMTC). The UE 104 may decode a SIB1 to detect the SMTC parameters. If the SMTC has a periodicity longer than a predetermined threshold, the UE 104 may determine the cell is an NES cell.

In some embodiments, the UE 104 may determine whether a candidate cell is in an NES cell based on a serving cell transmission. For example, the UE 104 may receive a SIB from serving cell 110 that includes a neighbor NES cell list. The neighbor NES cell list may include a list of cells in the vicinity of serving cell 110 that are NES cells. For example, in some embodiments, the NSC 112 may be an NES cell that is included in a neighbor NES cell list transmitted by the base station 108. A neighbor NES cell list for intra-frequency cell reselection may be provided in a SIB3 transmission. A neighbor NES cell list for inter-frequency cell reselection may be provided in a SIB4 transmission.

In some embodiments, the UE 104 may prioritize NES cells when performing a cell reselection. The prioritization may occur in one or more the following ways.

Embodiments include at least four options for prioritizing NES cells for reselection with respect to an inter-frequency cell reselection.

In a first option, NES cells and their frequencies may be associated with a relatively higher priority than non-NES cells and their frequencies. The relative priorities may be relied upon by the UE 104 when selecting a candidate cell for reselection.

In a second option, NES-capable UE dedicated frequency priority values may be broadcast in a SIB or RRC release message. An NES-capable UE may then use these priority values for cell reselection and may ignore legacy frequency priority values transmitted in the SIB or RRC release message. The legacy priority values may still be accessible to legacy UEs for their cell reselection operations. The legacy UEs will ignore the NES-capable UE dedicated frequency priority values.

In a third option, the scaling factor or offset may be configured. The scaling factor or offset may be used in accordance with a first or second suboption.

In a first suboption, the UE 104 may apply the scaling factor or offset to measurements performed on an NES cell while the UE 104 is in an RRC IDLE state, In some embodiments, the measurements may be receive level measurements (for example, reference signal receive power (RSRP)) or receive quality measurements (for example, reference signal receive quality (RSRQ)). In some embodiments, the scaling factor or offset may be applied to parameters associated with the measurements. For example, the scaling factor or offset may be applied to a time-to-trigger parameter (for example, Treselection_{RAT}) or a hysteresis offset (Qhyst) that is applied to the measurements. The Treselection_{RAT} and hysteresis offset Qhyst parameters may be used to allow cell reselection to happen faster or slower depending on how the scaling factor or offset is applied.

In the second suboption, the UE 104 may apply the scaling factor or offset to one or more cell reselection thresholds for identified NES cells and their frequencies. The thresholds may be receive-level thresholds (e.g., Srxlev thresholds) or receive-quality thresholds (e.g., Squal thresholds). For example, the UE 104 may apply the scaling factor or offset to: an Srxlev threshold (in decibels) for NR inter-frequency and inter-RAT measurements (S_nonIntraSearchP); an Squal threshold (in decibels) for NR inter-frequency and inter-RAT measurements (S_nonIntraSearchQ); an Srxlev threshold (in decibels) for reselecting towards a higher priority RAT/frequency than a current serving frequency (Thresh_X, HighP); an Srxlev threshold (in decibels) for reselecting towards a lower priority RAT/frequency than a current serving frequency (Thresh_X, LowP); an Squal threshold (in decibels) for reselecting towards a higher priority RAT/frequency than a current serving frequency (Thresh_X, HighQ); or an Squal threshold (in decibels) for reselecting towards a lower priority RAT/frequency than a current serving frequency (Thresh_X, LowQ).

In various embodiments, the UE 104 may perform cell ranking in a target frequency with respect to any of the above options for prioritizing NES cells when performing a cell reselection. The ranking may allow NES cells to be prioritized over non-NES cells, and may further provide a relative priority between the NES cells themselves.

The UE 104 may prioritize NES cells during intra-frequency cell reselection or inter-frequency cell reselection with a same priority using one or more of the following options.

A first option may apply when a rangeToBestCell parameter is configured in a SIB2. The rangeToBestCell specifies an R-value range. If the rangeToBestCell parameter is configured, the UE 104 may perform cell reselection to an NES cell with a shortest SSB periodicity among cells whose R values are within the R-value range of an R value of the highest ranked cell. If more than one cell shares the shortest SSB periodicity among the cells whose R values are within the R-value range of an R value of the highest ranked cell, the UE 104 may perform cell reselection to a highest ranked cell among them.

An R value for a neighbor cell may be a cell-ranking criteria represented as: R =Q_meas+Qoffset−Qoffset_temp: where Q_meas is an RSRP measurement quantity used in a cell reselection; Qoffset for intra-frequency is equal to a specified offset between the serving and neighbor cell (Qoffset_s,n), if Qofset_s,n is valid, otherwise equal to zero; Qoffset for inter-frequency is equal to Qoffset_s,n plus a frequency specific offset for equal priority frequencies (Qoffset_frequency) if Qoffset_s,n is valid, otherwise equal to zero.

In a second option for intra-frequency cell reselection or inter-frequency cell reselection with same priority, the UE 104 may access an NES cell-specific Qoffset that is provided in a SIB/RRC release message. The UE 104 may use the NES cell-specific Qoffset to generating the cell-ranking criteria, R, similar to that described above. In this manner, the NES cells may be ranked higher than non-NES cells.

In some instances, if the UE 104 is camped in, or served by, an NES cell, measurements performed on the cell may not be sufficient to satisfy RRM/radio link monitoring (RLM) requirements. Thus, in these instances, the UE 104 may apply the relaxed RRM/RLM requirements in determining whether the measurements are satisfied. This may avoid the UE 104 being forced to move from an NES cell prematurely.

While some embodiments allow an NES-enabled UE to identify non-NES cells for an initial cell selection and NES cells for cell reselection, some aspects of the present disclosure may also be designed in a manner such that a legacy UE avoids camping in an NES cell. This objective may be facilitated using one or more of the following options.

In a first option, NES-capable UE dedicated frequency priority values may be broadcast in a SIB. This may be similar to the second option described above with respect to prioritizing NES cells for reselection with respect to an inter-frequency cell reselection. As discussed above, an NES-capable UE may apply the NES-capable UE dedicated frequency priority values and ignore legacy priority values in a SIB or RRC release message. Conversely, the legacy UE may apply the legacy priority values from the SIB or RRC release message. The legacy priority values may be lower than the NES-capable UE dedicated frequency priority values.

In a second option, the UE 104 may provide an early indication to the network that it is an NES-capable UE. This early indication may be sent in one or more messages of a random-access channel (RACH) procedure. For example, the UE 104 may access a preamble that is specifically reserved to indicate that a UE is a NES-capable UE. This reserved preamble may be transmitted to the network in a message 1 (Msg 1) transmission. For another example, the UE 104 may access a message 3 (Msg 3) logical channel identifier (LCID) that is specifically reserved to indicate that a UE is a NES-capable UE. This reserved Msg 3 LCID may be transmitted to the network in a Msg 3 transmission.

In a third option, an NES cell may perform cell barring in a manner that prevents legacy UEs from connecting with the NES cell. For example, an NES cell may set a reservation parameter (for example, cellReservedForOtherUse or cellReservedForFutureUse) to true. The reservation parameter may be in a cell access related information element within a SIB1 transmitted by the NES cell. The NES cell may also provide a new indication that the cell is performing NES barring. The new indication may be in the SIB1 or another SIB. A legacy UE may access the reservation parameter and consider itself barred by the NES cell. An NES-capable UE, on the other hand, will determine that it is able to camp on the NES cell based on the indication that the cell is “performing NES barring” in the SIB.

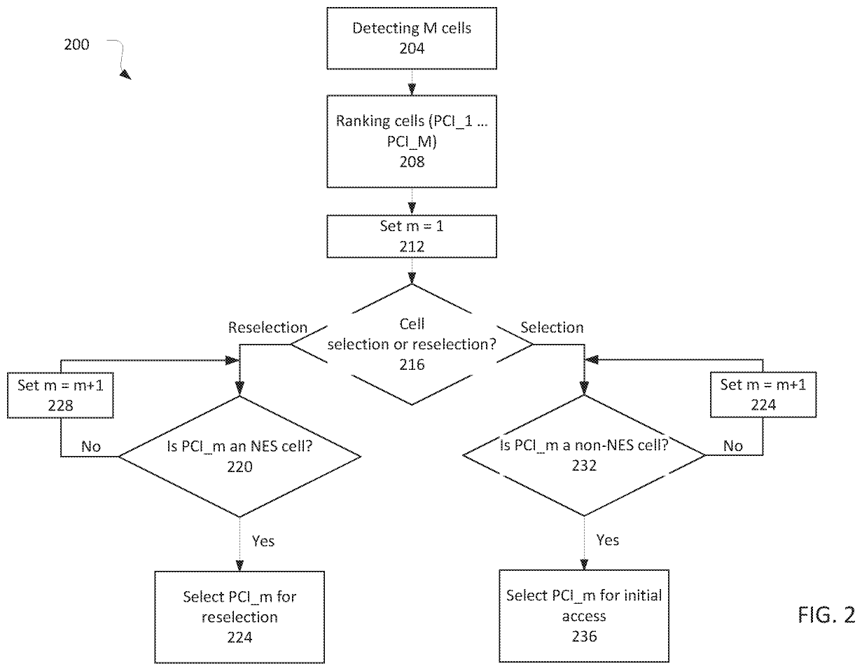

FIG. 2 is an operation flow/algorithmic structure 200 illustrating a cell selection or reselection in accordance with some aspects. The operation flow/algorithmic structure 200 may be performed or implemented by a UE, such as UE 104 or 600; or components thereof, for example, baseband processor 604A.

The operation flow/algorithmic structure 200 may include, at 204, detecting M candidate cells. In some embodiments, the M candidate cells may be the N strongest cells that are candidates for an initial cell selection. The strength may be based on one or more measurements of channel metrics including receive power or receive quality. In other embodiments, other selection criteria may be used to select the M candidate cells. The measurements may be performed on an SSB or other discovery reference signals.

The operation flow/algorithmic structure 200 may further include, at 208, ranking the cells from the highest to lowest. For example, a physical cell identity (PCI) associated with the most desirable measurements may be indicated as PCI_1, the PCI associated with the second most desirable measurements may be indicated as PCI_2, . . . , and the PCI of the M PCIs associated with the least desirable measurements (but still satisfying the selection criteria) may be indicated as PCI_M.

The operation flow/algorithmic structure 200 may further include, at 212, setting an index, m, equal to one.

The operation flow/algorithmic structure 200 may further include, at 216, determining whether the UE is performing an initial cell selection or a cell reselection.

If it is determined, at 216, that the UE is performing a cell reselection, the operation flow/algorithmic structure 200 may advance to determining whether a PCI_m cell is an NES cell at 220. This determination may be based on any of the embodiments described herein.

In some embodiments, the ranking of the cells 208 may provide the NES cells with a relatively higher ranking as compared to the non-NES cells. In these embodiments, for purposes of reselection, the UE may not make an explicit determination of whether a cell is an NES cell at 220. In these embodiments, this determination may be encompassed by the ranking process.

If it is determined, at 220, that the PCI_m is an NES cell, the UE may select the PCI m cell for reselection at 224.

If it is determined, at 220, that the PCI-m is not an NES cell, the UE may increment the index m at 228 and check the next PCI_m. This process may repeat until an NES cell is found. In some embodiments, if an NES cell is not found, the index m may be reset to 1 and the process may select a non-NES cell for reselection.

If it is determined, at 216, that the UE is performing an initial cell selection, the operation flow/algorithmic structure 200 may advance to determining whether a PCI_m cell is a non-NES cell at 232. This determination may be based on any of the embodiments described herein.

If it is determined, at 232, that the PCI_m is a non-NES cell, the UE may select the PCI_m cell for the initial cell selection at 236.

If it is determined, at 232, that the PCI_m is not a non-NES cell, the UE may increment the index m at 232 and check the next PCI_m. This process may repeat until a non-NES cell is found. In some embodiments, if no non-NES cell is found, the index m may be reset to 1 and the process may select an NES cell for initial cell selection.

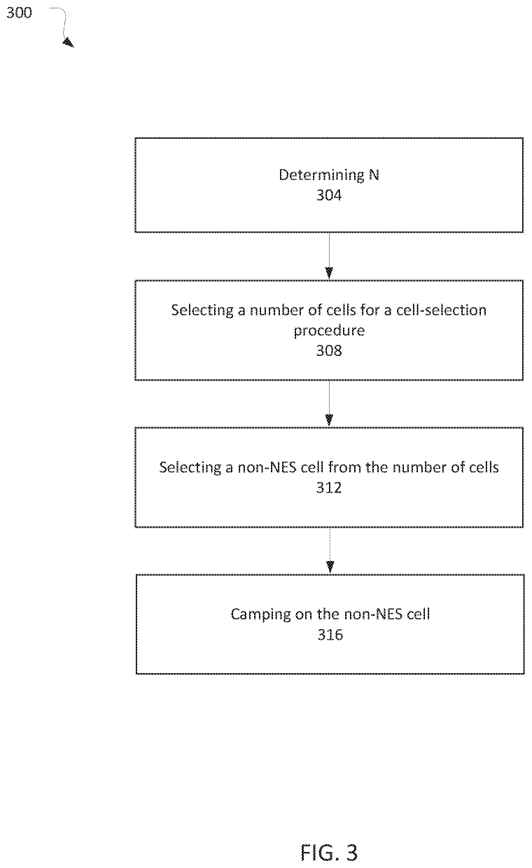

FIG. 3 illustrates an operation flow/algorithmic structure 300 in accordance with some aspects. The operation flow/algorithmic structure 300 may be performed or implemented by a UE, such as UE 104 or 600; or components thereof; for example, baseband processor 604A.

The operation flow/algorithmic structure 300 may include, at 304, determining an integer, N, that is greater than one. The integer may be determined by accessing it from memory of the UE. The integer may be predefined, associated with subscription information of the UE, or signaled in a SIB transmission.

The operation flow/algorithmic structure 300 may further include, at 308, selecting a number of cells for a cell-selection procedure. The selected cells may be considered candidate cells that satisfy a set of selection criteria. Except as otherwise described herein, the selection criteria may be similar to selection criteria described in 3GPP TS 38.304 v17.1.0 (2022-06). In some embodiments, the UE may use unrelaxed RRM requirements in the selection of the candidate cells.

The operation flow/algorithmic structure 300 may further include, at 312, selecting a non-NES cell from the number of candidate cells. In some embodiments, the candidate cells may be ranked based on ranking criteria. Except as otherwise described herein, the ranking criteria may be similar to ranking criteria described in 3GPP TS 38.304.

In some embodiments, selection of the non-NES cell may be ensured or encouraged by incorporating the NES type into the selection or ranking criteria. For example, the selection criteria may additionally include a requirement that the candidate cells be non-NES cells. For another example, the ranking criteria may prioritize non-NES cells for the initial cell selection. In this manner, if no suitable non-NES cells are available, the UE may be able to select an NES cell for camping, even if it is less preferable for reasons discussed elsewhere herein.

The operation flow/algorithmic structure 300 may further include, at 316, camping on the non-NES cell.

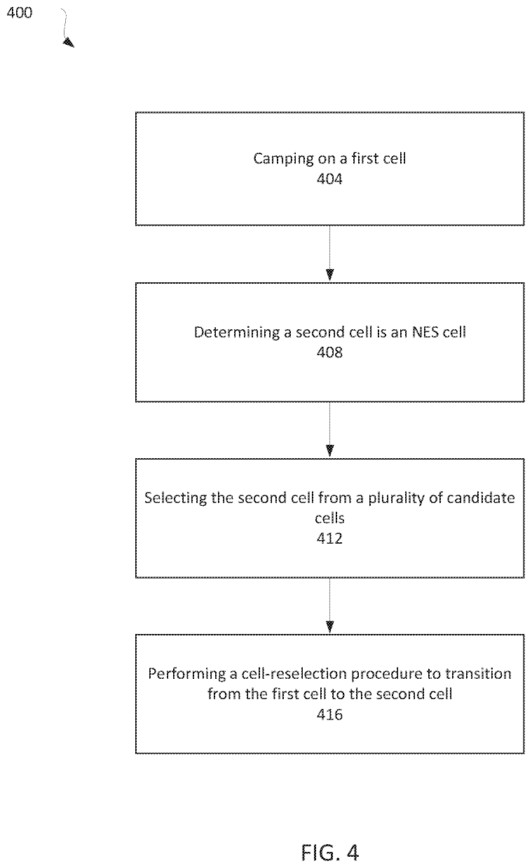

FIG. 4 illustrates an operation flow/algorithmic structure 400 in accordance with some aspects. The operation flow/algorithmic structure 400 may be performed or implemented by a UE, such as UE 104 or 600; or components thereof; for example, baseband processor 604A.

The operation flow/algorithmic structure 400 may include, at 404, camping on a first cell. The first cell may be an NES cell or a non-NES cell. The UE may be camped on the first cell in an RRC idle state or an RRC inactive state.

While camped, the UE may detect a trigger to initiate a cell-reselection procedure. In some embodiments, the trigger may be related to RRM or RLM procedures performed while camped on the first cell. If the first cell is an NES cell, the UE may apply relaxed RRM/RLM requirements. If the first cell is a non-NES cell, the UE may apply unrelaxed RRM/RLM requirements.

The operation flow/algorithmic structure 400 may further include, at 408, determining a second cell is an NES cell. In some embodiments, the UE may make this determination based on a bit value in a SIB; a detected periodicity of a SSB; a SIB1 parameter indicating whether an SSB is present or a SIB1 is broadcast; whether a cell DRX/DTX configuration is present in a SIB; whether discovery reference signal is detected; or an SMTC periodicity.

In some embodiments, the UE may determine the second cell is an NES cell based on its presence in a neighbor NES cell list that is provided by the first cell. The neighbor NES cell list may be transmitted in a SIB3 transmission if the UE is performing an intra-frequency reselection, or in a SIB4 transmission if the UE is performing an inter-frequency reselection.

The operation flow/algorithmic structure 400 may further include, at 412, selecting the second cell from a plurality of candidate cells. The selection of the second cell may be based on a ranking criteria that sets the second cell as a most preferred target for reselection. In some embodiments, the plurality of candidate cells may include both non-NES cells and NES cells. The NES cells may be associated with a reselection priority that is higher than a reselection priority associated with the non-NES cells. The prioritization may occur as described elsewhere herein. For example,

The operation flow/algorithmic structure 400 may further include, at 416, performing a cell-reselection procedure to transition from the first cell to the second cell.

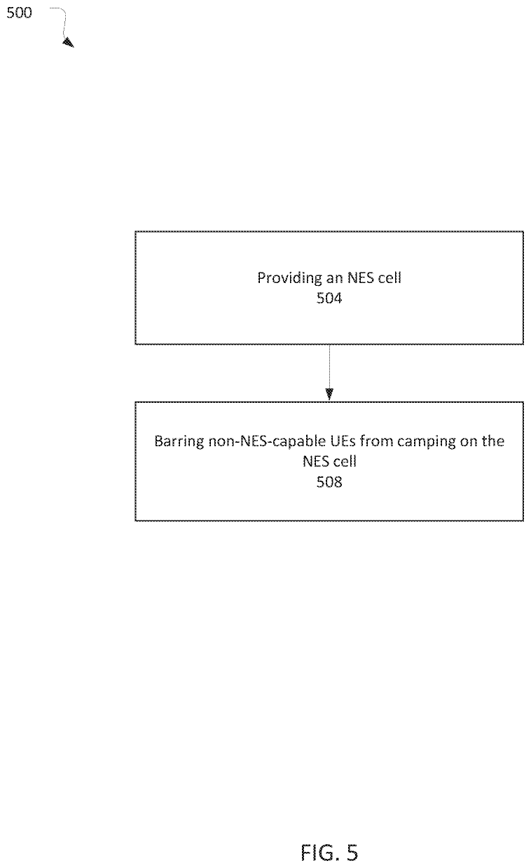

FIG. 5 illustrates an operation flow/algorithmic structure 500 in accordance with some aspects. The operation flow/algorithmic structure 500 may be performed or implemented by a base station, such as base station 108 or 700, or components thereof; for example, baseband processor 704A.

The operation flow/algorithmic structure 500 may include, at 504, providing an NES cell. The NES cell may be provided by employing one or more of the NES techniques described herein.

The operation flow/algorithmic structure 500 may further include, at 508, barring non-NES-capable (for example, legacy) UEs from the NES cell. In some embodiments, the barring of legacy UEs may be performed by determining an absence of an early indication in a RACH procedure and rejecting the UE that is attempting to connect with the NES cell. In other embodiments, the barring of legacy UEs may be performed by setting a reservation parameter to true in a SIB1 in conjunction with providing a new indication that the NES cell is “performing NES barring.” The new indication may be provided in the SIB1 or in another SIB.

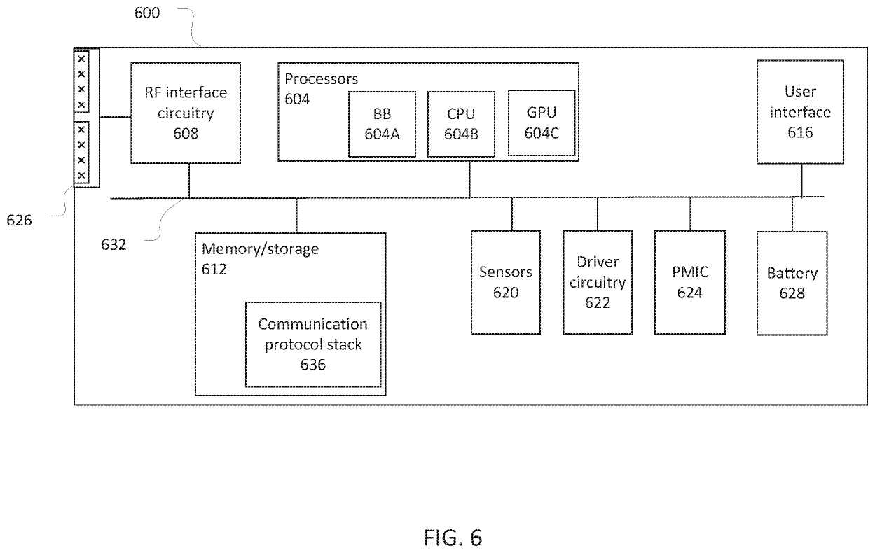

FIG. 6 illustrates a UE 600 in accordance with some embodiments. The UE 600 may be similar to and substantially interchangeable with UE 104 of FIG. 1.

The UE 600 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 600 may include processors 604, RF interface circuitry 608, memory/storage 612, user interface 616, sensors 620, driver circuitry 622, power management integrated circuit (PMIC) 624, antenna structure 626, and battery 628. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 632, which may represent any type of interface, input/output, bus (local, system, or expansion), transmission line, trace, or optical connection that allows various circuit components (on common or different chips or chipsets) to interact with one another.

The processors 604 may include processor circuitry such as, for example, baseband processor circuitry (BB) 604A, central processor unit circuitry (CPU) 604B, and graphics processor unit circuitry (GPU) 604C. The processors 604 may include any type of circuitry or processor circuitry that executes or otherwise operates computer-executable instructions, such as program code, software modules, or functional processes from memory/storage 612 to cause the UE 600 to perform operations as described herein.

In some embodiments, the baseband processor circuitry 604A may access a communication protocol stack 636 in the memory/storage 612 to communicate over a 3GPP compatible network. In general, the baseband processor circuitry 604A may access the communication protocol stack 636 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 608.

The baseband processor circuitry 604A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 612 may include one or more non-transitory, computer-readable media that includes instructions (for example, communication protocol stack 636) that may be executed by one or more of the processors 604 to cause the UE 600 to perform various operations described herein. The memory/storage 612 include any type of volatile or non-volatile memory that may be distributed throughout the UE 600. In some embodiments, some of the memory/storage 612 may be located on the processors 604 themselves (for example, L1 and L2 cache), while other memory/storage 612 is external to the processors 604 but accessible thereto via a memory interface. The memory/storage 612 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 608 may include transceiver circuitry and radio frequency front module (RFEM) that allows the UE 600 to communicate with other devices over a radio access network. The RF interface circuitry 608 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 626 and proceed to filter and amplify (with a low-noise amplifier) the signal. The signal may be provided to a receiver of the transceiver that down-converts the RF signal into a baseband signal that is provided to the baseband processor of the processors 604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 626.

In various embodiments, the RF interface circuitry 608 may be configured to transmit/receive signals in a manner compatible with NR access technologies.

The antenna 626 may include antenna elements to convert electrical signals into radio waves to travel through the air and to convert received radio waves into electrical signals. The antenna elements may be arranged into one or more antenna panels. The antenna 626 may have antenna panels that are omnidirectional, directional, or a combination thereof to enable beamforming and multiple input, multiple output communications. The antenna 626 may include microstrip antennas, printed antennas fabricated on the surface of one or more printed circuit boards, patch antennas, or phased array antennas. The antenna 626 may have one or more panels designed for specific frequency bands including bands in FR1 or FR2.

The user interface circuitry 616 includes various input/output (I/O) devices designed to enable user interaction with the UE 600. The user interface 616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 600.

The sensors 620 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 622 may include software and hardware elements that operate to control particular devices that are embedded in the UE 600, attached to the UE 600, or otherwise communicatively coupled with the UE 600. The driver circuitry 622 may include individual drivers allowing other components to interact with or control various I/O devices that may be present within, or connected to, the UE 600. For example, the driver circuitry 612 may include circuitry to facilitate coupling of a UICC (for example, UICC 68) to the UE 600. For additional examples, driver circuitry 622 may include a display driver to control and allow access to a display device, a touchscreen driver to control and allow access to a touchscreen interface, sensor drivers to obtain sensor readings of sensor circuitry 620 and control and allow access to sensor circuitry 620, drivers to obtain actuator positions of electro-mechanic components or control and allow access to the electro-mechanic components, a camera driver to control and allow access to an embedded image capture device, audio drivers to control and allow access to one or more audio devices.

The PMIC 624 may manage power provided to various components of the UE 600. In particular, with respect to the processors 604, the PMIC 624 may control power-source selection, voltage scaling, battery charging, or DC-to-DC conversion.

In some embodiments, the PMIC 624 may control, or otherwise be part of, various power saving mechanisms of the UE 600 including DRX as discussed herein.

A battery 628 may power the UE 600, although in some examples the UE 600 may be mounted deployed in a fixed location, and may have a power supply coupled to an electrical grid. The battery 628 may be a lithium ion battery, a metal-air battery, such as a zinc-air battery, an aluminum-air battery, a lithium-air battery, and the like. In some implementations, such as in vehicle-based applications, the battery 628 may be a typical lead-acid automotive battery.

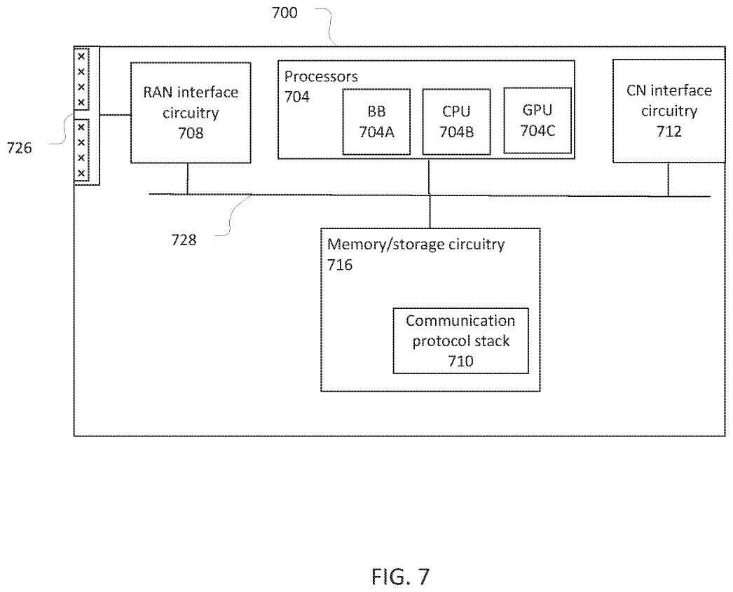

FIG. 7 illustrates a base station 700 in accordance with some embodiments. The base station 700 may be similar to and substantially interchangeable with base station 108 or 116.

The base station 700 may include processors 704, RF interface circuitry 708 (if implemented as an access node), core network (CN) interface circuitry 712, memory/storage circuitry 716, and antenna structure 726.

The components of the base station 700 may be coupled with various other components over one or more interconnects 728.

The processors 704, RF interface circuitry 708, memory/storage circuitry 716 (including communication protocol stack 710), antenna structure 726, and interconnects 728 may be similar to like-named elements shown and described with respect to FIG. 6.

The CN interface circuitry 712 may provide connectivity to a core network, for example, a 5th Generation Core network (5GC) using a 5GC-compatible network interface protocol such as carrier Ethernet protocols, or some other suitable protocol. Network connectivity may be provided to/from the base station 700 via a fiber optic or wireless backhaul. The CN interface circuitry 712 may include one or more dedicated processors or FPGAs to communicate using one or more of the aforementioned protocols. In some implementations, the CN interface circuitry 712 may include multiple controllers to provide connectivity to other networks using the same or different protocols.

In some embodiments, the base station 700 may be coupled with transmit receive points (TRPs) using the antenna structure 726, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a user equipment (UE), the method comprising: determining an integer that is greater than one; selecting a number of cells for a cell-selection procedure, the number being equal to or less than the integer; selecting, from the number of cells, a non-network energy-saving (NES) cell; and camping on the non-NES cell.

Example 2 includes a method of example 1 or some other example herein, wherein the UE is an NES-capable UE.

Example 3 includes method of example 1 or some other example herein, wherein determining the integer comprises: accessing the integer from memory of the UE, wherein the integer is predefined, associated with subscription information of the UE, or signaled by a system information block (SIB).

Example 4 includes a method of example 1 or some other example herein, further comprising: storing a set of relaxed radio resource management (RRM) requirements and a set of unrelaxed RRM requirements; using the set of unrelaxed RRM requirements in the cell-selection procedure.

Example 5 includes a method of example 4 some other example herein, further comprising: performing a cell reselection procedure using the set of relaxed RRM requirements.

Example 6 includes a method of operating a user equipment (UE), the method comprising: camping on a first cell; determining a second cell is a network energy-saving (NES) cell; selecting the second cell from a plurality of candidate cells based on said determining the second cell is an NES cell; and performing a cell-reselection procedure to transition from the first cell to the second cell based on said selecting the second cell.

Example 7 includes a method of example 6 or some other example herein, further comprising: storing a set of relaxed radio resource management (RRM) requirements and a set of unrelaxed RRM requirements; and performing the cell-reselection procedure based on the set of relaxed RRM requirements.

Example 8 includes the method of example 7 or some other example herein, further comprising: performing an RRM or radio link monitoring procedure using the set of relaxed RRM requirements while camped on the second cell.

Example 9 includes the method of example 6 or some other example herein, wherein determining the second cell is an NES cell comprises: determining the second cell is an NES cell based on: a bit value in a system information block (SIB); a detected periodicity of a synchronization signal block (SSB); a system information block 1 (SIB1) parameter indicating whether an SSB is present; whether a SIB1 is broadcast; whether an uplink wake up signal (WUS) configuration is present in a SIB; whether a cell discontinuous reception (DRX) or discontinuous transmission (DTX) configuration is present in a SIB, whether a discovery reference signal is detected; or an SSB measurement timing configuration (SMTC) periodicity.

Example 10 includes the method of example 6 or some other example herein, wherein determining the second cell is an NES cell comprises: receiving, from the first cell, a neighbor NES cell list that indicates the second cell is an NES cell.

Example 11 includes the method of example 10 or some other example herein, wherein: the neighbor NES cell list is for intra-frequency cell reselection and is provided in a system information block 3 (SIB3) transmission; or is for inter-frequency cell reselection and is provided in a system information block 4 (SIB4) transmission.

Example 12 includes the method of example 6 or some other example herein, further comprising: determining NES cells are associated with a first reselection priority; determining non-NES cells are associated with a second reselection priority; and selecting the second cell from the plurality of candidate cells based on the first reselection priority being greater than the second reselection priority.

Example 13 includes the method of example 12 or some other example herein, wherein determining NES cells are associated with a first reselection priority comprises: receiving a first set of frequency priority values associated with NES cells, the first set of frequency priority values corresponding to the first reselection priority; and receiving a second set of frequency priority values associated with non-NES cells, the second set of frequency priority values corresponding to the second reselection priority.

Example 14 includes the method of example 12 or some other example herein, wherein selecting the second cell from the plurality of candidate cells further comprises: identifying a scaling factor or offset; and comparing a measurement of the second cell with cell reselection criteria associated with the cell reselection procedure based on the scaling factor or offset.

Example 15 includes the method of example 14 or some other example herein, further comprising: applying the scaling factor or offset to: a parameter applied to the measurement of the second cell, the measurement of the second cell, or the cell reselection criteria.

Example 16 includes the method of example 15 or some other example herein, wherein the scaling factor or offset is applied to a parameter used to obtain the measurement of the second cell, the parameter being time-to-trigger parameter or a hysteresis offset.

Example 17 includes the method of example 15 or some other example herein, wherein the scaling factor or offset is applied to the measurement of the second cell and the measurement is a reference signal received power (RSRP) measurement or a reference signal received quality (RSRQ) measurement.

Example 18 includes the method of example 15 or some other example herein, wherein the scaling factor or offset is applied to the cell reselection criteria and the cell reselection criteria is a cell selection receive level value threshold; or a cell selection quality level threshold for inter-frequency or inter-RAT measurements.

Example 19 includes the method of example 6 or some other example herein, further comprising: performing a cell ranking in a target frequency; and selecting the second cell based on the cell ranking.

Example 20 includes the method of example 19 or some other example herein, further comprising: determining range-to-best-cell parameter that provides a value range; selecting a plurality of NES cells that have a neighbor-cell ranking criterion (R) value within the value range; and performing the cell ranking on the plurality of NES cells.

Example 21 includes the method of example 20 or some other example herein, further comprising: determining the second cell has a shortest synchronization signal block (SSB) periodicity of the plurality of NES cells; and selecting the second cell based on said determining the second cell has the shortest SSB periodicity.

Example 22 includes the method of example 20 or some other example herein, further comprising: receiving, in a system information block or radio resource control release message, an NES cell-specific Qoffset; and determining the R value based on the NES cell-specific Qoffset.

Example 23 includes the method of example 6 or some other example herein, further comprising: transmitting an indication that the UE is an NES-capable UE in a message 1 or a message 3 of a random-access channel (RACH) procedure.

Example 24 includes the method of example 6 or some other example herein, further comprising: detecting, in a system information block 1 (SIB1) transmission, an indication that the second cell is a cell reserved for other use or a cell reserved for future use; and detecting, in a broadcast message, an indication that the second cell is performing NES barring.

Example 25 includes a method of operating a base station, the method comprising: providing a network energy-saving (NES) cell; and barring non-NES-capable UEs from camping on the NES cell.

Example 26 includes the method of example 25 or some other example herein, wherein barring non-NES-capable UEs from camping on the NES serving cell comprises: determining, based on an absence of an early indication in a random-access channel (RACH) procedure with a first UE, the first UE is a non-NES-capable UE; and rejecting access to the first UE based on said determining the first UE is a non-NES-capable UE.

Example 27 includes the method of example 25 or some other example herein, wherein barring non-NES-capable UEs from camping on the NES serving cell comprises: transmitting, in a system information block 1 (SIB1) transmission, an indication that the NES serving cell is a cell reserved for other use or a cell reserved for future use; and transmitting, in a broadcast message, an indication that the NES serving cell is performing NES barring. Another example may include an apparatus comprising means to perform one or more elements of a method described in or related to any of examples 1-27, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-27, or any other method or process described herein.

Another example may include an apparatus comprising logic, modules, or circuitry to perform one or more elements of a method described in or related to any of examples 1-27, or any other method or process described herein.

Another example may include a method, technique, or process as described in or related to any of examples 1-27, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-27, or portions thereof.

Another example may include a signal as described in or related to any of examples 1-27, or portions or parts thereof.

Another example may include a datagram, information element, packet, frame, segment, PDU, or message as described in or related to any of examples 1-27, or portions or parts thereof, or otherwise described in the present disclosure.

Another example may include a signal encoded with data as described in or related to any of examples 1-27, or portions or parts thereof, or otherwise described in the present disclosure.

Another example may include a signal encoded with a datagram, IE, packet, frame, segment, PDU, or message as described in or related to any of examples 1-27, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-27, or portions thereof.

Another example may include a computer program comprising instructions, wherein execution of the program by a processing element is to cause the processing element to carry out the method, techniques, or process as described in or related to any of examples 1-27, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-27. (canceled)

28. A method comprising:
camping on a first cell;
determining a second cell is a network energy-saving (NES) cell;
selecting the second cell from a plurality of candidate cells based on said determining the second cell is an NES cell; and
performing a cell-reselection procedure to transition from the first cell to the second cell based on said selecting the second cell.

29. The method of claim 28, further comprising:
storing a set of relaxed radio resource management (RRM) requirements and a set of unrelaxed RRM requirements; and
performing the cell-reselection procedure based on the set of relaxed RRM requirements.

30. The method of claim 28, wherein determining the second cell is an NES cell comprises:
determining the second cell is an NES cell based on: a bit value in a system information block (SIB); a detected periodicity of a synchronization signal block (SSB); a system information block 1 (SIB1) parameter indicating whether an SSB is present; whether a SIB1 is broadcast; whether an uplink wake up signal (WUS) configuration is present in a SIB; whether a cell discontinuous reception (DRX) or discontinuous transmission (DTX) configuration is present in a SIB, whether a discovery reference signal is detected; or an SSB measurement timing configuration (SMTC) periodicity; or
receiving, from the first cell, a neighbor NES cell list that indicates the second cell is an NES cell.

31. The method of claim 28, further comprising:
determining NES cells are associated with a first reselection priority;
determining non-NES cells are associated with a second reselection priority; and
selecting the second cell from the plurality of candidate cells based on the first reselection priority being greater than the second reselection priority.

32. The method of claim 31, wherein determining NES cells are associated with a first reselection priority comprises:
receiving a first set of frequency priority values associated with NES cells, the first set of frequency priority values corresponding to the first reselection priority; and
receiving a second set of frequency priority values associated with non-NES cells, the second set of frequency priority values corresponding to the second reselection priority.

33. The method of claim 31, wherein selecting the second cell from the plurality of candidate cells further comprises:
identifying a scaling factor or offset; and
comparing a measurement of the second cell with cell reselection criteria associated with the cell reselection procedure based on the scaling factor or offset.

34. The method of claim 28, further comprising:
performing a cell ranking in a target frequency; and
selecting the second cell based on the cell ranking.

35. The method of claim 34, further comprising:
determining range-to-best-cell parameter that provides a value range;
selecting a plurality of NES cells that have a neighbor-cell ranking criterion (R) value within the value range; and
performing the cell ranking on the plurality of NES cells.

36. The method of claim 28, further comprising:
generating, for transmission, a message 1 or a message 3 of a random-access channel (RACH) procedure, wherein the message 1 or the message 3 includes an indication that a user equipment (UE) is an NES-capable UE.

37. The method of claim 28, further comprising:
detecting, in a system information block 1 (SIB1) transmission, an indication that the second cell is a cell reserved for other use or a cell reserved for future use; and
detecting, in a broadcast message, an indication that the second cell is performing NES barring.

38. The method of claim 28, further comprising:
determining an integer that is greater than one;
selecting a number of cells for a cell-selection procedure, the number being equal to or less than the integer;
selecting, from the number of cells, the first cell for said camping, wherein the first cell is a non-NES cell.

39. A method comprising:
determining dedicated priority values to be used for cell reselection by network energy-saving (NES)-capable user equipments (UEs); and
generating a message for transmission, the message to include the dedicated priority values.

40. The method of claim 39, wherein the dedicated priority values are associated with specific frequencies; or
wherein the dedicated priority values indicate a relative priority of one or more NES cells or frequencies compared with one or more non-NES cells or frequencies.

41. The method of claim 39, wherein the dedicated priority values include a scaling factor or offset associated with a frequency or cell.

42. The method of claim 39, further comprising barring non-NES-capable UEs from camping on an NES cell, wherein barring non-NES-capable UEs from camping on the NES cell comprises:
determining, based on an absence of an early indication in a random-access channel (RACH) procedure with a first UE, the first UE is a non-NES-capable UE, and rejecting access to the first UE based on said determining the first UE is a non-NES-capable UE; or
generating, for transmission in a system information block 1 (SIB1) transmission, an indication that the NES cell is a cell reserved for other use or a cell reserved for future use, and generating, for transmission in a broadcast message, an indication that the NES serving cell is performing NES barring.

43. An apparatus comprising:
processor circuitry to:
identify dedicated priority values to be used for cell reselection by network energy-saving (NES)-capable user equipments (UEs); and
perform cell reselection based on the dedicated priority values; and
interface circuitry coupled to the processor circuitry to enable communication.

44. The apparatus of claim 43, wherein the dedicated priority values are associated with specific frequencies.

45. The apparatus of claim 43, wherein the dedicated priority values are received in a system information block (SIB) or a radio resource control (RRC) release message.

46. The apparatus of claim 43, wherein the dedicated priority values indicate a relative priority of one or more NES cells or frequencies compared with one or more non-NES cells or frequencies.

47. The apparatus of claim 43, wherein the dedicated priority values include a scaling factor or offset associated with a frequency or cell.
